(19) United States
(12) Patent Application Publication
(10) Pub. No.: US 2023/0220708 A1
(43) Pub. Date: Jul. 13, 2023

(54) MULTI-POINT LATCH ASSEMBLY

(71) Applicant: GRIZZLY COOLERS, LLC, Decorah, IA (US)

(72) Inventors: Greg Lewey, Decorah, IA (US); Luke Mount, Decorah, IA (US); Sam Mount, Decorah, IA (US); Jeremy Merrill, Ft Atkinson, IA (US)

(21) Appl. No.: 18/151,897

(22) Filed: Jan. 9, 2023

Related U.S. Application Data
(60) Provisional application No. 63/297,366, filed on Jan. 7, 2022.

(51) Int. Cl. E05C 9/18; E05C 3/04

(52) U.S. Cl. CPC E05C 9/1858; E05C 3/04

(57) ABSTRACT

The disclosure provided herein is directed to a multipoint latch assembly that may include a handle assembly with a cam plate and an upper latch assembly and a lower latch assembly connected to the cam plate. A handle latch ball assembly connects to the upper latch assembly, an upper latch ball assembly connected to the upper latch assembly, and a lower latch ball assembly connected to the lower latch assembly. Rollers of the handle latch ball assembly, the upper latch ball assembly, and the lower latch ball assembly diminish or eliminate noise created when opening or closing a door of a hunting blind.

### CROSS REFERENCE TO RELATED APPLICATION

This application claims the benefit U.S. Provisional Application Ser. No. 63/297,366 filed Jan. 7, 2022; the contents of this application is hereby incorporated by reference in their entirety.

### BACKGROUND OF THE INVENTION

This disclosure generally relates to a latch assembly. More specifically, the disclosure, in various aspects, relates to multipoint latch assembly used in relation to a door of a hunting blind.

Hunting often requires a hunter to be exposed to environmental conditions (e.g., weather and temperature) in undeveloped areas for extended periods of time. Avoiding detection while hunting is also a paramount consideration. If a hunter is seen, heard, or smelled, game will avoid the area the hunter is located at.

To protect themselves from these elements and avoid detection, hunters often use hunting blinds which are enclosures that are configured to be mobile such that the hunting blind can be repositioned as needed. To avoid the hunting blind being seen, the exterior is often camouflaged.

While hunting blinds are useful, problems remain. The doors of hunting blinds are conventionally secured by a single point latch assembly that secures the door to a shell of the hunting blind. Forces such as wind can bend the shell of the hunting blind that is, in some instances, rotomolded from a low-density polyethylene or similar plastic that is subject to deforming and sagging from such forces, as well as warping caused by variation in temperature extremes or temperature differentials between the interior of the hunting blind and the outside environment. When the fitment of the door of the hunting blind fails, elements such as rain can enter the hunting blind as well as insects and other pests.

Another prominent issue with single point latch assemblies is the noise created during usage. As the elements that comprise the latch assembly are manipulated, noise is created when the door is opened and closed. While hunting, any noise created by the hunter can alert game of the hunter's presence, leading the game to avoid or depart from the area in which the noise originated.

Thus, it is a primary aspect of this disclosure to provide a multipoint latch assembly that improves upon the art.

Another aspect of this disclosure is to provide a multipoint latch assembly that provides silent or near-silent operation.

Yet another aspect of this disclosure is to provide a multipoint latch assembly that resists warping, sagging, and deforming.

These and other aspects, features, and advantages of the invention will become apparent from the specification and claims.

### SUMMARY OF THE INVENTION

The disclosure provides various aspects of a multipoint latch assembly.

In some aspects of the disclosure, broadly described herein, the techniques relate to a multipoint latch assembly including: a handle assembly having a cam plate; an upper latch assembly and a lower latch assembly connected to the cam plate; a handle latch ball assembly connected to the handle assembly; the handle latch ball assembly having a first roller; an upper latch ball assembly connected to the upper latch assembly; the upper latch ball assembly having a second roller; a lower latch ball assembly connected to the lower latch assembly; and the lower latch ball assembly having a third roller.

In some aspects, broadly described herein, the techniques relate to a multipoint latch assembly further including at least one of the first roller, the second roller, and the third roller having a sphere shape with an opening extending between antipodal points.

In some aspects, broadly described herein, the techniques relate to a multipoint latch assembly further including at least one of the first roller, the second roller, and the third roller having a sleeve positioned through the opening.

In some aspects, broadly described herein, the techniques relate to a multipoint latch assembly further including the sleeve having a protrusion, wherein a diameter of the protrusion is greater than the diameter of a remainder of the sleeve.

In some aspects, broadly described herein, the techniques relate to a multipoint latch assembly wherein at least one of the first roller, the second roller, and the third roller is made of an ethylene propylene monomer exterior around a polypropylene core.

In some aspects, broadly described herein, the techniques relate to a multipoint latch assembly further including the upper latch ball assembly connected to a pair of upper flanges of the upper latch assembly, and the lower latch ball assembly connected to a pair of lower flanges of the lower latch assembly.

In some aspects, broadly described herein, the techniques relate to a multipoint latch assembly further including the upper latch assembly having a first bushing connected to the cam plate, and the lower latch assembly having a second bushing connected to the cam plate, wherein the first bushing and the second bushing are made of polypropylene.

In some aspects, broadly described herein, the techniques relate to a multipoint latch assembly further including the upper latch assembly having an upper arm, the upper arm having an upper slot and an upper door connection assembly connected to a door through the upper slot, the lower latch assembly having a lower arm, the lower arm having a lower slot and a lower door connection assembly connected to the door through the lower slot.

In some aspects, broadly described herein, the techniques relate to a multipoint latch assembly further including the upper door connection assembly having a first bushing and a lower door connection assembly having a second bushing, wherein the first bushing and the second bushing are made of polypropylene.

In some aspects, broadly described herein, the techniques relate to a multipoint latch assembly further including the upper latch assembly having a first distal edge that is concave in shape and the lower latch assembly having a second distal edge that is concave in shape, wherein the first distal edge is shaped to provide space for the second roller and the second distal edge is shaped to provide space for the third roller.

In some aspects, broadly described herein, the techniques relate to a multipoint latch assembly further including having a lateral flange that extends perpendicularly in relation to a plane extending from an upper side to a lower side of the cam plate, wherein the handle latch ball assembly connects to the lateral flange.

In some aspects, broadly described herein, the techniques relate to a multipoint latch assembly further including the handle assembly having a spindle that extends through the cam plate and a lock assembly, and the lock assembly having a lock rotating bracket and a lock fixed rotating bracket.

In some aspects, broadly described herein, the techniques relate to a multipoint latch assembly further including the lock rotating bracket having a circular opening and the lock fixed rotating bracket having a square opening.

In some aspects, broadly described herein, the techniques relate to a multipoint latch assembly further including a door having a recess at a lower end of the door and an upper end of the door, wherein the second roller and the third roller are received in the recess at the upper end and the lower end when the upper latch assembly and the lower latch assembly are in an open position.

In some aspects, broadly described herein, the techniques relate to a multipoint latch assembly further including the handle assembly, the upper latch assembly, and the lower latch assembly connected to a door of a hunting blind.

In some aspects, broadly described herein, the techniques relate to a multipoint latch assembly wherein in a closed position, the handle latch ball assembly, the upper latch ball assembly, and the lower latch ball assembly engage a shell of the hunting blind such that the door of the hunting blind cannot be opened.

In some aspects, broadly described herein, the techniques relate to a multipoint latch assembly wherein in an open position, the handle latch ball assembly, the upper latch ball assembly, and the lower latch ball assembly engage the door of the hunting blind such that the door of the hunting blind can be opened.

In some aspects, broadly described herein, the techniques relate to a multipoint latch assembly wherein transitioning between the closed position to the open position the upper latch assembly and the lower latch assembly are retracted toward the cam plate, and the handle latch ball assembly is rotated about the cam plate.

This has outlined, rather broadly, the features, advantages, solutions, and benefits of the disclosure in order that the description that follows may be better understood. Additional features, advantages, solutions, and benefits of the disclosure will be described in the following. It should be appreciated by those skilled in the art that this disclosure may be readily utilized as a basis for modifying or designing other structures and related operations for carrying out the same purposes of the present disclosure. It should also be realized by those skilled in the art that such equivalent constructions and related operation do not depart from the teachings of the disclosure as set forth in the appended claims. The novel features, together with further objects and advantages, will be better understood from the following description when considered in connection with the accompanying Figures. It is to be expressly understood, however, that each of the Figures is provided for the purpose of illustration and description only and is not intended as a definition of the limits of the present disclosure.

### BRIEF DESCRIPTION OF THE DRAWINGS

FIG. 1 is a front view of a multipoint latch assembly according to an aspect of the disclosure;

FIG. 2 is a perspective view of a multipoint latch assembly according to an aspect of the disclosure;

FIG. 3 is an exploded view of a multipoint latch assembly according to an aspect of the disclosure;

FIG. 4 is a close-up perspective view of a multipoint latch assembly according to an aspect of the disclosure as indicated in FIG. 2;

FIG. 5 is a close-up perspective view of a multipoint latch assembly according to an aspect of the disclosure as indicated in FIG. 2; and

FIG. 6 is a close-up perspective view of a multipoint latch assembly according to an aspect of the disclosure as indicated in FIG. 2;

FIG. 7 is close-up exploded view of a multipoint latch assembly according to an aspect of the disclosure as indicated in FIG. 3;

FIG. 8 is close-up exploded view of a multipoint latch assembly according to an aspect of the disclosure as indicated in FIG. 3;

FIG. 9 is close-up exploded view of a multipoint latch assembly according to an aspect of the disclosure as indicated in FIG. 3

FIG. 10 is a washer of a multipoint latch assembly according to an aspect of the disclosure; and

FIG. 11 is a latch ball assembly of a multipoint latch assembly according to an aspect of the disclosure.

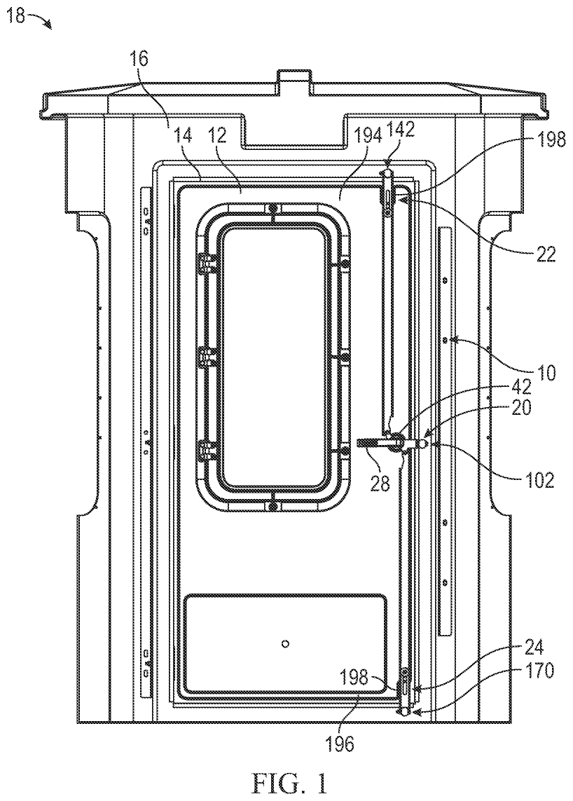

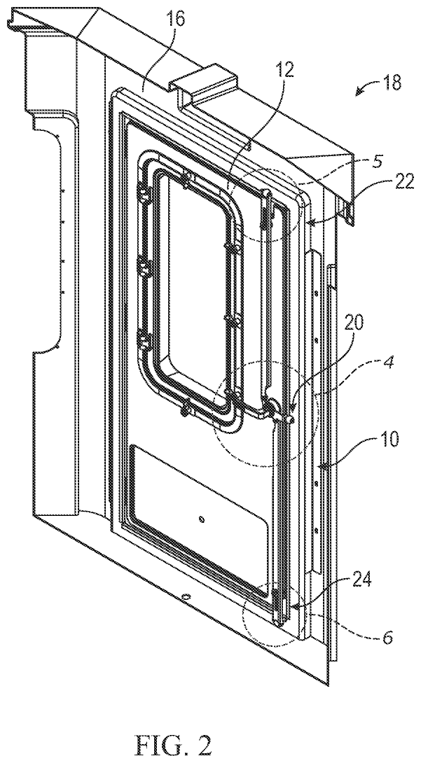

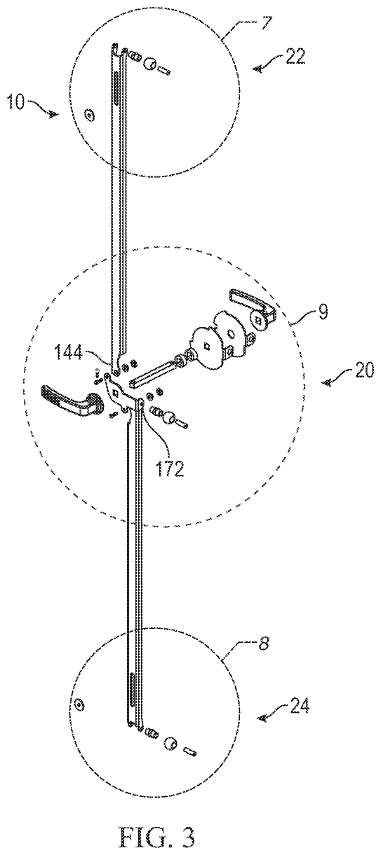

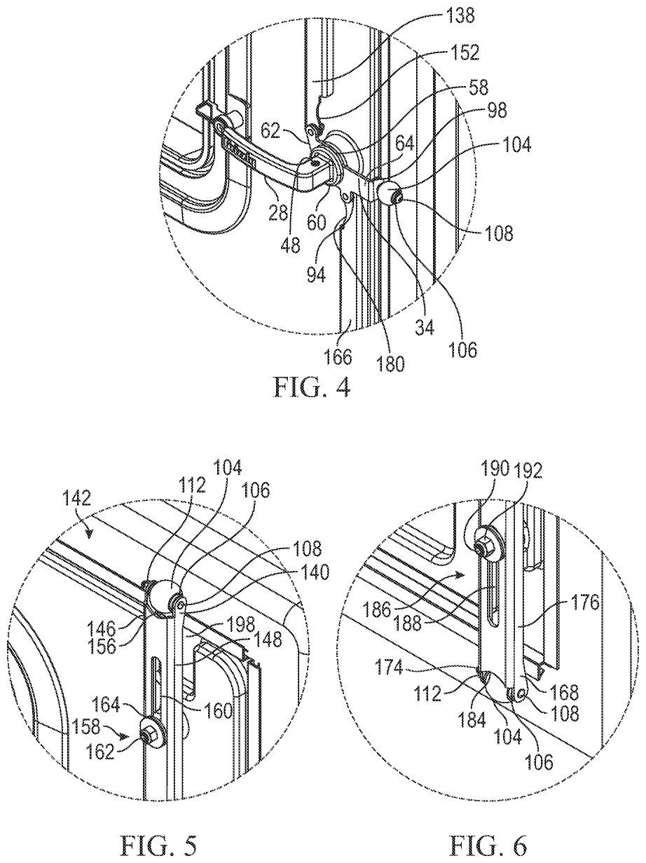

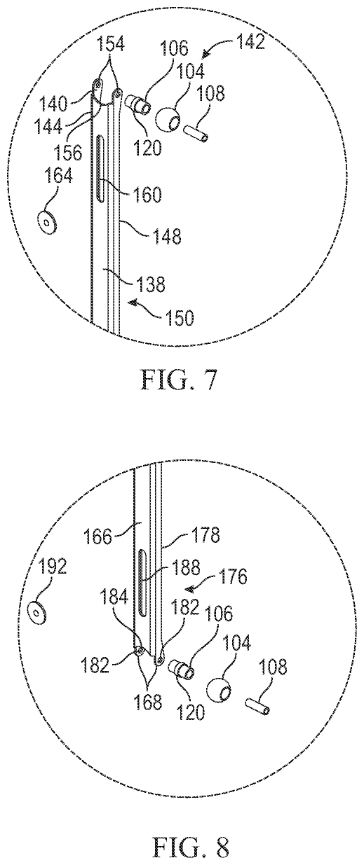

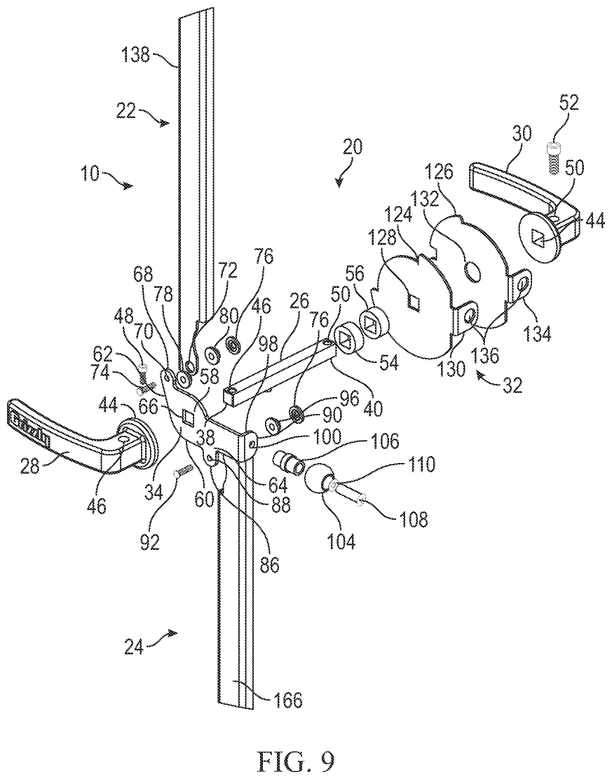

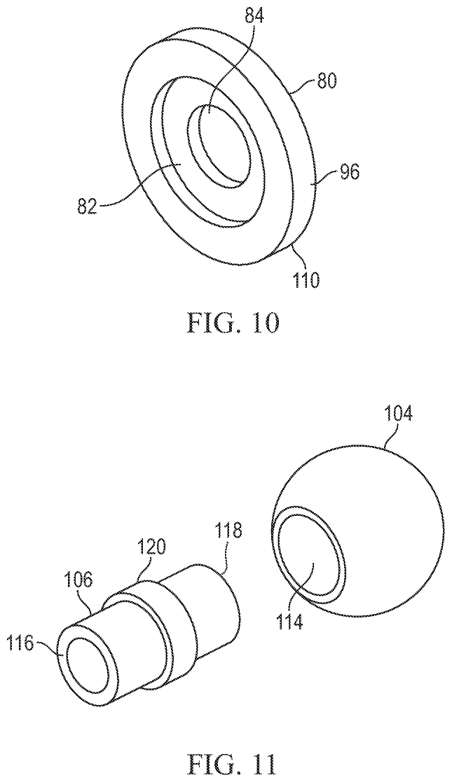

### DETAILED DESCRIPTION

The disclosure described herein is directed to different aspects of a multipoint latch assembly. The detailed description set forth below, in connection with the appended drawings, is intended as a description of various configurations and is not intended to represent the only configurations in which the concepts described herein may be practiced. These descriptions include specific details for the purpose of providing a thorough understanding of the various concepts. The disclosure is described herein with reference to certain aspects, iterations, embodiments, and examples but it is understood that the disclosure can be embodied in many different forms and should not be construed as limited to the aspects set forth herein. It will be apparent, however, to those skilled in the art that these concepts may be practiced without these specific details. As described herein, the use of the term “and/or” is intended to represent an “inclusive OR”, and the use of the term “or” is intended to represent an “exclusive OR”.

Although the terms first, second, etc. may be used herein to describe various elements or components, these elements or components should not be limited by these terms. These terms are only used to distinguish one element or component from another. Hence, a first element discussed herein could be termed a second element without departing from the teachings of the present application. It is understood that actual systems or fixtures embodying the disclosure can be arranged in many different ways with many more features and elements beyond what is shown in the drawings. For the same or similar elements or features, the same reference numbers may be used throughout the disclosure.

It is to be understood that when an element or component is referred to as being “on” another element or component, it can be directly on the other element or intervening elements may also be present. Furthermore, relative terms such as “between”, “within”, “below”, and similar terms, may be used herein to describe a relationship of one element or component to another. It is understood that these terms are intended to encompass different orientations of the disclosure in addition to the orientation depicted in the figures.

With reference to the Figures, aspects of a multipoint latch assembly 10 for a door 12 that seals an opening 14 in a shell 16 of a hunting blind 18. In aspects of the present invention, the multipoint latch assembly 10 comprises one or more of a handle assembly 20, an upper latch assembly 22, and a lower latch assembly 24.

In some aspects, the handle assembly 20 further comprises one or more of a spindle 26, an interior handle 28, an exterior handle 30, a lock assembly 32, and a cam plate 34. In some such configurations, the interior handle 28 and the exterior handle 30 are configured to rotate the spindle 26, whereas the lock assembly 32 is configured to receive a lock 36 (not shown) to prevent the spindle 26 from rotating. The handle assembly 20, in some aspects of the present invention, is configured to transition the upper latch assembly 22 and the lower latch assembly 24 to allow the door 12 to open and securely close.

In further aspects, the spindle 26 extends from and between a first or interior end 38 to a second or exterior end 40. In some aspects, the interior end 38 and the exterior end 40 are deburred and have a bevel to facilitate connection with the interior handle 28 and exterior handle 30. In still further aspects, the spindle 26 is cuboid with a rectangular side profile, which facilitates operation when the spindle 26 is received through square openings as described with respect to various aspects disclosed herein. In various aspects, the spindle 26 is made of aluminum.

In other aspects, the spindle 26 is received through a door opening 42 in the door 12, which in some aspects, positions the spindle 26 with equal or substantially equal lengths of the spindle 26 extending from opposing sides of the door 12. In further aspects, the interior handle 28 has an opening 44 that receives the interior end 38 of the spindle 26. In other aspects, the interior handle 28 and the interior end 38 each have an interior opening 46 that are aligned with one another such that, in still other aspects, an interior handle connector 48 is received in through the interior opening 46 of the interior handle 28 and interior end 38 to secure the two together. In some aspects, the interior handle connector 48 is a screw, a set screw, a button head screw, or the like. To facilitate insertion of the interior handle connector 48, the interior opening 46 of the spindle 26 and/or the interior handle 28 is deburred.

In still further aspects, the exterior handle 30, akin to the interior handle 28, has an opening 44 that receives the exterior end 40 of the spindle 26. In yet other aspects, the exterior handle 30 and the exterior end 40 of the spindle 26 each have an exterior opening 50 that are aligned with one another such that, in other aspects, an exterior handle connector 52 is received through the exterior opening 50 of the exterior handle 30 and the exterior end 40 to secure the exterior handle 30 to the spindle 26. In some aspects of the present invention, the exterior handle connector 52 is a screw, a set screw, a button head screw, or the like. To facilitate insertion of the exterior handle connector 52, the exterior opening 50 of the spindle 26 and/or the exterior handle 30 is deburred.

In certain aspects, the interior handle 28 and/or the exterior handle 30 are L-shaped. In some such configurations, the interior handle 28 and/or the exterior handle 30 extend in a medial direction in relation to the door 12 and are configured to rotate clockwise and/or counter-clockwise to operate the multipoint latch assembly 10 as described herein.

In other aspects, an interior axle bearing 54 is received on the spindle 26 between the door 12 and the interior handle 28. In some aspects, an exterior axle bearing 56 is received on the spindle 26 between the door 12 and the exterior handle 30. In such aspects having the interior axle bearing 54 and/or the exterior axle bearing 56, the interior axle bearing 54 and/or the exterior axle bearing 56 is made of a plastic, including polypropylene. The use of such materials provides the unique benefit of minimizing, if not eliminating, the noise associated with operation of the multipoint latch assembly 10 as described herein.

In still further aspects, the cam plate 34 is received on the spindle 26, which in some such aspects is positioned between the interior handle 28 and the interior axle bearing 54. In particular aspects, the cam plate 34 comprises a top or upper side 58, a bottom or lower side 60, a first or medial side 62, and a second or lateral side 64. In still other aspects, a cam plate opening 66 is positioned through the cam plate 34 to receive the spindle 26. In some such aspects, the cam plate opening 66 is square to provide rotational engagement with the spindle 26 when the spindle 26 is turned, such as by way of the opening 44 of the interior handle 28 and/or exterior handle 30 that, in some aspects, are also square to provide similar rotational engagement.

In some aspects, the cam plate 34 has an upper cam flange 68 that extends from and above the upper side 58 of the cam plate 34. In some such aspects, the upper cam flange 68 extends along the same plane as the cam plate 34. In still other aspects, the upper cam flange 68 extends in alignment with the medial side 62 of the cam plate 34. In other aspects, the upper cam flange 68 has an upper cam flange opening 70 that aligns with an upper arm opening 72 of the upper latch assembly 22 as disclosed further herein. In further aspects, an upper cam connector 74 is received through the upper cam flange opening 70 and the upper arm opening 72. In some aspects, the upper cam connector 74 is a press fit stud, but in other aspects is a screw, button head screw, or the like. The use of the press fit stud reduces the likelihood of the upper cam connector 74 becoming loose over time. In still further aspects, the upper cam connector 74 has a nut 76, which in some aspects is a nylon-insert lock nut (a.k.a. nyloc), that secures the upper cam connector 74.

In yet further aspects, an upper cam bushing 78 is received on the upper cam connector 74 between the upper cam flange 68 and the upper latch assembly 22. In some such aspects, the upper cam bushing 78 is made of a polypropylene that provides the unique benefit of providing silent or near-silent operation of the multipoint latch assembly 10 as described herein. In further aspects, the upper cam bushing 78 is made of other plastics. In other aspects, an upper cam washer 80 is received on the upper cam connector 74 opposite the upper cam bushing 78 adjacent or abutting the upper latch assembly 22, which in some aspects positions the upper cam washer 80 between the upper latch assembly 22 and the nut 76. In certain aspects of the present invention comprising the upper cam washer 80, the upper cam washer 80 has a recess 82 that extends from an opening 84 in the center of the upper cam washer 80 such that the recess 82 reduces the thickness of the upper cam washer 80. In yet further aspects, the upper cam washer 80 is made of polypropylene that provides the unique dampening benefits described herein. Similarly, the recess 82 enhances the dampening benefit as the recess allows for compression of and the cushioning provided by the upper cam washer 80.

In further aspects of the present invention, the cam plate 34 has a lower cam flange 86 that extends from and below the lower side 60 of the cam plate 34. In certain aspects, the lower cam flange 86 extends along the same plane as the cam plate 34. In some aspects, the lower cam flange 86 has a lower cam flange opening 88 that aligns with a lower arm opening 90 of the lower latch assembly 24 as disclosed further herein. In yet other aspects, a lower cam connector 92 is received through the lower cam flange opening 88 and the lower arm opening 90. In certain aspects, the lower cam connector 92 is a press fit stud, that provides the unique benefit of reducing the likelihood that the lower cam connector 92 become loose over time. In other aspects, the lower cam connector 92 is a screw, button head screw, or the like. In yet further aspects, the lower cam connector 92 also has the nut 76 to secure the lower cam connector 92 with the handle assembly 20 and lower latch assembly 24.

In other aspects, a lower cam bushing 94 is received on the lower cam connector 92 between the lower cam flange 86 and the lower latch assembly 24. In certain such aspects, the lower cam bushing 94. is made of a polypropylene that provides the unique benefit of providing silent or near-silent operation of the multipoint latch assembly 10 as described herein, but in other aspects is made of other plastics. In still further aspects, a lower cam washer 96 is received on the lower cam connector 92 adjacent or abutting the lower latch assembly 24 opposite the lower cam bushing 94 such that in some certain aspects, the lower cam washer 96 is positioned between the lower latch assembly 24 and the nut 76 of the lower cam connector 92. In some aspects, the lower cam washer 96 has the recess 82 as described in relation to the upper cam washer 80 thereby providing the same unique benefits described herein.

In further aspects of the present invention, the cam plate 34 has a lateral flange 98 that extends from the lateral side 64 of the cam plate 34 and away from the medial side 62. The lateral flange 98, in some aspects, extends perpendicularly inwards from the plane from which the cam plate 34 extends between the upper side 58 to the lower side 60 such that the lateral flange 98 extends towards the exterior end 40 of the spindle 26. In further aspects, the lateral flange 98 has a lateral flange opening 100.

In still other aspects, a handle latch ball assembly 102 is connected to the handle assembly 20. In some aspects, the handle latch ball assembly 102 comprises one or more of a roller 104, a sleeve 106, a latch ball connector 108, a washer 110, and a nut 112. In certain aspects, the roller 104 has a ball-like or spherical shape with an aperture 114 extending between antipodal points on the roller 104. Such shapes minimize the point or surface of contact between the multipoint latch assembly 10 and the door 12 and the shell 16 thereby providing a quieter operation compared to configurations with larger areas of contact. In further aspects, the roller 104 is made of an ethylene propylene diene monomer (EPDM) exterior around a polypropylene core, which provides the unique benefit of allowing fluid rotation of the roller 104 as discussed herein while also providing a silent or near-silent operation of the multipoint latch assembly 10. In other aspects, the roller 104 is made of other rubber material that while still useful do not achieve the same advantages.

In further aspects, the sleeve 106 has a tubular shape that extends from and between a first end 116 to a second end 118 of the sleeve 106. In particular aspects, the sleeve 106 is made of polypropylene to achieve the dampening benefits described herein, but in other aspects, the sleeve 106 is material of other plastics or other material. In other aspects, the sleeve 106 has a portion or protrusion 120 with a larger diameter than the rest of the sleeve 106 that in some aspects is positioned at a midpoint between the first end 116 and the second end 118. The sleeve 106 is received within the aperture 114, in some aspects, and the protrusion 120 having the greater diameter is the only part of the sleeve 106 that is in contact with the roller 104. In such a configuration, the roller 104 is able to flex further due to the smaller diameter of the sleeve 106 outside of the protrusion 120. In yet other aspects, the length of the sleeve 106 is such that the first end 116 and the second end 118 are positioned outside of the roller 104 when received in the aperture 114.

In some aspects, the handle latch ball assembly 102 connects to the lower cam flange 86 of the cam plate 34. The latch ball connector 108, in various aspects of the present invention, is received through the sleeve 106 and thus the aperture 114. The latch ball connector 108, with respect to the handle latch ball assembly 102, in certain aspects, is also received through the lower cam flange opening 88 in the lower cam flange 86 to connect the handle latch ball assembly 102 to the cam plate 34. In some aspects, the latch ball connector 108 is a press fit stud or press fit fastener to provide the advantage of avoiding coming loose over time. In other aspects, the latch ball connector 108 is a screw, button head screw, or the like. In yet further aspects, the latch ball connector 108 has the nut 112 to secure the latch ball connector 108 with the handle assembly 20, wherein some aspects the nut 112 is a nyloc nut. In further aspects, the sleeve 106 is positioned such that the latch ball connector 108 prevents the sleeve 106 from rotating during operation such that only the roller 104 rotates. In still other aspects, the washer 110 is positioned between the sleeve 106 and the latch ball connector 108, which in some aspects the washer 110 has the same characteristics, structure, and advantages of the upper cam washer 80 and the lower cam washer 96.

In some aspects of the present invention, the lock assembly 32 is received on the spindle 26, which in some such aspects is positioned between the exterior handle 30 and the exterior axle bearing 56. The lock assembly 32, according to aspects of the present invention, comprises one or more of a lock rotating bracket 124 and a lock fixed bracket 126. In some aspects, the lock rotating bracket 124 has a square opening 128 that the spindle 26 is received through. In other aspects, a first perpendicular flange 130 extends perpendicularly from the lock rotating bracket 124 towards the exterior handle 30. In further aspects, the lock fixed bracket 126 has a circular opening 132 that the spindle 26 is received through. Like the lock rotating bracket 124, a second perpendicular flange 134 extends perpendicularly from the lock fixed bracket 126 towards the exterior handle 30. When the multipoint latch assembly 10 is in a closed position, the first perpendicular flange 130 and the second perpendicular flange 134 overlap with another such that a lock opening 136 of each is in alignment with the other. The lock opening 136, in some aspects, is configured to receive the lock 36. As the circular opening 132 does not match the shape of the spindle 26 (i.e., cuboid and square) the rotation of the spindle 26 does not rotate the lock fixed bracket 126, whereas the spindle 26 does rotate the lock rotating bracket 124. In aspects where the lock 36 is received through each respective lock opening 136, the lock 36 prevents the lock rotating bracket 124 from rotating by engagement with the lock fixed bracket 126.

In other aspects, the upper latch assembly 22 comprises one or more of an upper arm 138, a pair of upper arm flanges 140, and an upper latch ball assembly 142. The upper arm 138, in some aspects, extends between and from a first or proximal end 144 to a second or distal end 146. In other aspects of the present invention, the upper arm 138 forms a channel 148 or has a generally U-shape. A recess 150 of the channel 148 is positioned towards the door 12. In particular aspects, the upper arm 138 is made of cold rolled steel in order to provide superior rigidity to the upper latch assembly 22.

In still other aspects, the proximal end 144 of the upper arm 138 has a cutout 152 positioned adjacent the cam plate 34 to prevent the upper arm 138 from striking the cam plate 34 during operation as discussed herein. The upper arm opening 72, in further aspects, is positioned at or adjacent the proximal end 144 of the upper arm 138, which as discussed previously, is used to connect the upper cam flange 68 to the upper latch assembly 22 with the upper cam connector 74.

At the distal end 146 of the upper arm 138, the pair of upper arm flanges 140 extends distally away from the upper arm 138, in some aspects of the present invention. In another aspect, the pair of upper arm flanges 140 have a pair of aligned upper flange openings 154. In further aspects, the upper latch ball assembly 142 is received and connected between the pair of upper arm flanges 140. The upper latch ball assembly 142, in some aspects, is comprised of one or more of the roller 104, the sleeve 106, the latch ball connector 108, the washer, and the nut 112 as discussed above herein with relation to the handle latch ball assembly 102. In some aspects where the sleeve 106 is prevented from rotating during operation, a tolerance of the inside dimension of the channel 148, i.e., a width of the recess 150, is such as to prevent rotation of the sleeve 106 after the latch ball connector 108 is secured through the pair of upper arm flanges 140 and the sleeve 106. In other aspects of the present invention, a distal edge 156 of the upper arm 138 is concave in shape as to provide a space for the roller 104.

Below the distal edge 156, in various aspects of the present invention, is an upper door connector assembly 158. In some such aspects, the upper door connector assembly 158 comprises one or more of an upper slot 160 in the upper arm 138 below the distal edge 156, an upper door connector 162, and an upper arm bushing 164 positioned through the upper slot 160. In further aspects, the upper door connector 162 is received through the upper arm bushing 164 and into the door 12. In this way, the upper door connector 162 is positioned through the upper arm 138 but only engages the upper arm bushing 164. The upper door connector 162 is a screw, button head screw, push fit fastener, or the like. As the upper door connector 162 is in a static, fixed position, the likelihood of becoming loose is diminished. The upper arm bushing 164, in some aspects, is made of polypropylene which dampens the sound of operation of the multipoint latch assembly 10 as described herein.

In still other aspects, the lower latch assembly 24 comprises one or more of a lower arm 166, a pair of lower arm flanges 168, and lower latch ball assembly 170. The lower arm 166 like the upper arm 138, in some aspects, extends between and from a first or proximal end 172 to a second or distal end 174. In other aspects, the lower arm 166 also forms a channel 176 having a general U-shape with a recess 178 that is positioned towards the door 12. In some aspects, the lower arm 166 is made of cold rolled steel.

In still other aspects, the proximal end 172 of the lower arm 166 has a cutout 180 positioned adjacent the cam plate 34 to prevent the lower arm 166 from striking the cam plate 34 during operation. The lower arm opening 90, in further aspects, is positioned at or adjacent the proximal end 172, which as discussed previously, is used to connect the lower cam flange 86 to the lower latch assembly 24.

In further aspects, the pair of lower arm flanges 168 extend distally away from the distal end of the lower arm 166. In some aspects, the pair of lower arm flanges 168 have a pair of aligned openings 182. In yet further aspects, the lower latch ball assembly 170 is received and connected between the pair of lower arm flanges 168, wherein, the lower latch ball assembly 170 comprises one or more of the roller 104, the sleeve 106, the latch ball connector 108, the washer, and the nut 112 as discussed above herein. In certain aspects where the sleeve 106 is prevented from rotating during operation, a tolerance of the inside dimension of the channel 176 is such as to prevent rotation of the sleeve 106 after the latch ball connector 108 is secured through the pair of lower arm flanges 168 and the sleeve 106. In other aspects of the present invention, a distal edge 184 of the lower arm 166 is concave in shape as to provide a space for the roller 104.

Above the distal edge 184, in other aspects of the invention, is a lower door connector assembly 186. In some such aspects, the lower door connector assembly 186 comprises one or more of a lower slot 188 in the lower arm 166 above the distal edge 184, a lower door connector 190, and a lower arm bushing 192 positioned through the lower slot 188. In certain aspects, the lower door connector 190 is received through the lower arm bushing 192 and into the door 12. In this way, the lower door connector 190 is positioned through the lower arm 166 but only engages the lower arm bushing 192. The lower door connector 190, in various aspects, is a screw, button head screw, push fit fastener, or the like. As the lower door connector 190 is in a static, fixed position, the likelihood of becoming loose is diminished. The lower arm bushing 192, in some aspects, is made of polypropylene which dampens the sound of operation of the multipoint latch assembly 10 as described herein.

In another aspect of the present invention, an upper end 194 and/or a lower end 196 of the door 12 have a recess 198. In such configurations, the recess 198 is positioned to receive the roller 104 of the upper latch ball assembly 142 and/or the lower latch ball assembly 170 as the upper latch assembly 22 and the lower latch assembly 24 are retracted thereby pulling the roller 104 away from the shell 16 and onto the door 12 and into the recess 198.

In an operation according to aspects of this disclosure and the Figures, multipoint latch assembly 10 maintains the seal of the door 12 by engagement of the roller 104 of each of the handle latch ball assembly 102, the upper latch ball assembly 142, and the lower latch ball assembly 170. When the door 12 is to be opened, either the interior handle 28 or exterior handle 30 is turned counterclockwise, which in turn rotates the cam plate 34 about the spindle 26. As the cam plate 34 turns, the upper latch assembly 22 including the upper latch ball assembly 142 is pulled downward or retracts along a path or track formed by the interaction between the upper slot 160 and the upper arm bushing 164. Likewise, the lower latch assembly 24 including the lower latch ball assembly 170 is pulled upward or retracts along a path or track formed by an interaction between the lower slot 188 and the lower arm bushing 192. Simultaneously, the handle latch ball assembly 102 is rotated upwardly and inwardly as the cam plate 34 rotates. As this occurs, each roller 104 of the handle latch ball assembly 102, the upper latch ball assembly 142, and the lower latch ball assembly 170 are moved away from engaging the shell 16 and are positioned on the door 12 thereby allowing the door 12 to be opened as the multipoint latch assembly 10 is no longer in engagement with the shell 16. When the interior handle 28 or exterior handle 30 is rotated back clockwise, the process is reversed and each roller 104 again engages the shell 16, preventing the door 12 from opening. As described herein, the various aspects of the disclosure provide an operation that is silent or near silent.

Therefore, a multipoint latch assembly 10 has been provided that provides silent or near-silent operation, resists warping, sagging, and deforming, and improves upon the art.

From the above discussion and accompanying figures and claims it will be appreciated that the multipoint latch assembly 10 offers many advantages over the prior art. Although the present disclosure and its advantages have been described in detail, it should be understood that various changes, substitutions, modifications, and alterations can be made herein without departing from the technology of the disclosure as defined by the appended claims. The scope of the present application is not intended to be limited to the particular configurations of the process, machine, manufacture, composition of matter, means, methods and steps described in the specification only expressly stated otherwise. As one of ordinary skill in the art will readily appreciate from the disclosure, processes, machines, manufacture, compositions of matter, means, methods, or steps, presently existing or later to be developed that perform substantially the same function or achieve substantially the same result as the corresponding configurations described herein may be utilized according to the present disclosure. Accordingly, the appended claims are intended to include within their scope such processes, machines, manufacture, compositions of matter, means, methods, or steps.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A multipoint latch assembly comprising:
a handle assembly having a cam plate;
an upper latch assembly and a lower latch assembly connected to the cam plate;
a handle latch ball assembly connected to the handle assembly;
the handle latch ball assembly having a first roller;
an upper latch ball assembly connected to the upper latch assembly;
the upper latch ball assembly having a second roller;
a lower latch ball assembly connected to the lower latch assembly; and
the lower latch ball assembly having a third roller.

2. The multipoint latch assembly of claim 1 further comprising at least one of the first roller, the second roller, and the third roller having a sphere shape with an opening extending between antipodal points.

3. The multipoint latch assembly of claim 2 further comprising at least one of the first roller, the second roller, and the third roller having a sleeve positioned through the opening.

4. The multipoint latch assembly of claim 3 further comprising the sleeve having a protrusion, wherein a diameter of the protrusion is greater than the diameter of a remainder of the sleeve.

5. The multipoint latch assembly of claim 1 wherein at least one of the first roller, the second roller, and the third roller is made of an ethylene propylene monomer exterior around a polypropylene core.

6. The multipoint latch assembly of claim 1 further comprising the upper latch ball assembly connected to a pair of upper flanges of the upper latch assembly, and the lower latch ball assembly connected to a pair of lower flanges of the lower latch assembly.

7. The multipoint latch assembly of claim 1 further comprising the upper latch assembly having a first bushing connected to the cam plate, and the lower latch assembly having a second bushing connected to the cam plate, wherein the first bushing and the second bushing are made of polypropylene.

8. The multipoint latch assembly of claim 1 further comprising the upper latch assembly having an upper arm, the upper arm having an upper slot and an upper door connection assembly connected to a door through the upper slot, the lower latch assembly having a lower arm, the lower arm having a lower slot and a lower door connection assembly connect to the door through the lower slot.

9. The multipoint latch assembly of claim 8 further comprising the upper door connection assembly having a first bushing and a lower door connection assembly having a second bushing, wherein the first bushing and the second bushing are made of polypropylene.

10. The multipoint latch assembly of claim 1 further comprising the upper latch assembly having a first distal edge that is concave in shape and the lower latch assembly having a second distal edge that is concave in shape, wherein the first distal edge is shaped to provide space for the second roller and the second distal edge is shaped to provide space for the third roller.

11. The multipoint latch assembly of claim 1 further comprising having a lateral flange that extends perpendicularly in relation to a plane extending from an upper side to a lower side of the cam plate, wherein the handle latch ball assembly connects to the lateral flange.

12. The multipoint latch assembly of claim 1 further comprising the handle assembly having a spindle that extends through the cam plate and a lock assembly, and the lock assembly having a lock rotating bracket and a lock fixed rotating bracket.

13. The multipoint latch assembly of claim 12 further comprising the lock rotating bracket having a circular opening and the lock fixed rotating bracket having a square opening.

14. The multipoint latch assembly of claim 1 further comprising a door having a recess at a lower end of the door and an upper end of the door, wherein the second roller and the third roller are received in the recess at the upper end and the lower end when the upper latch assembly and the lower latch assembly are in an open position.

15. The multipoint latch assembly of claim 1 further comprising the handle assembly, the upper latch assembly, and the lower latch assembly connected to a door of a hunting blind.

16. The multipoint latch assembly of claim 15 wherein in a closed position, the handle latch ball assembly, the upper latch ball assembly, and the lower latch ball assembly engage a shell of the hunting blind such that the door of the hunting blind cannot be opened.

17. The multipoint latch assembly of claim 16 wherein in an open position, the handle latch ball assembly, the upper latch ball assembly, and the lower latch ball assembly engage the door of the hunting blind such that the door of the hunting blind can be opened.

18. The multipoint latch assembly of claim 17 wherein transitioning between the closed position to the open position the upper latch assembly and the lower latch assembly are retracted toward the cam plate, and the handle latch ball assembly is rotated about the cam plate.
